(19) United States
(12) Patent Application Publication
(10) Pub. No.: US 2002/0122022 A1
(43) Pub. Date: Sep. 5, 2002

(54) System and method for LCD thermal compensation

(76) Inventor: Ryan Tze, Irvine, CA (US)

Correspondence Address: PILLSBURY WINTHROP LLP, 725 South Figueroa Street, Suite 2800, Los Angeles, CA, 90017-5406, US

(21) Appl. No.: 09/800,237

(22) Filed: Mar. 5, 2001

(51) Int. Cl. G09G 3/36

(52) U.S. Cl. 345/101

(57) ABSTRACT

Embodiments of the present invention are generally directed to a system and method for compensating for variations in the temperature of the liquid crystal medium of a LCD panel to maintain a desired contrast level. According the embodiments of the invention, one or more temperature sensors, such as thermistors, may measure the temperature of ambient air in contact with one or more surfaces of the LCD panel. The voltage applied to selected pixels of the LCD panel may be altered based upon the temperature measured by the temperature sensor(s). The temperature sensor(s) may be thermally uncoupled from the LCD panel itself.

### BACKGROUND

In many electronic applications, information is displayed to a user through a liquid crystal display (LCD). Although generally not used in applications that require complex graphics, LCDs may be beneficial in applications that require low power and relatively simple graphics. For example, LCDs may be used in servers, copiers, or other office equipment to output status information to a user.

One problem arising from the use of LCDs is that the contrast of a liquid crystal image is dependent upon its temperature. The liquid crystal medium is generally more opaque at lower temperatures and more transparent at higher temperatures. When the liquid crystal medium is highly transparent, it may be difficult for a user to visualize the information being displayed. Therefore, it may be desirable to compensate for crystal temperature when supplying power to a LCD so that a roughly constant level of opacity may be maintained throughout operation.

Prior systems for performing LCD thermal compensation have involved the attachment of temperature sensors to LCDs. For example, in the system described in U.S. Pat. No. 5,029,982 to Nash, a LCD mounted in the wall of a computer case consists of crystal sandwiched between two plates, an inner plate facing the interior of the computer and an outer plate facing the ambient air. A temperature sensor is mounted to each plate, effectively yielding the temperatures of the ambient air outside the computer case and of the ambient air inside the computer case. Based on the readings of the sensors, the temperature throughout the LCD is profiled so that the temperature of the liquid crystal medium can be estimated. In alternative embodiments, a heat-conductive element is connected to both two plates, yielding a member with a temperature equal to the average of the two plates' temperatures. A single temperature sensor measures this average temperature for compensation purposes.

A problem with such arrangements is that it is often difficult to accurately measure the temperature of the ambient while still placing the sensor in a protected and thermally isolated place within the case of the electronic appliance. Moreover, where the sensor must be attached to the LCD panel itself, the complexity of manufacturing the product often increases.

### SUMMARY

Embodiments of the present invention are generally directed to a system and method for compensating for changes in the temperature of a LCD's liquid crystal medium so as to maintain a relatively constant-contrast visual output. According to embodiments of the invention, a thermistor or other temperature sensor may be used to measure the temperature of the ambient air outside the case of an electronic device and/or the temperature of the ambient air inside the case of the electronic device. The measurements may be used to determine the temperature of the LCD's liquid crystal medium and compensate for changes in this temperature by altering the voltage supplied to illuminate LCD pixels. According to embodiments of the present invention, thermistors or temperature sensors used to measure the temperatures of outside or inside ambient air may not be thermally coupled to portions of the LCD. Instead these thermistors or thermal sensors may be located inside the case of the electronic device and may be thermally isolated from the LCD itself. The thermistors or thermal sensors may be fed inside or outside ambient air by fans and may be located on the same circuit boards as other electronic components for ease of manufacture.

### BRIEF DESCRIPTION OF THE DRAWINGS

FIG. 1 depicts a cross-section of a LCD that may be used according to an embodiment of the present invention;

FIG. 2 illustrates a circuit that may be used according to embodiments of the present invention to operate a LCD;

FIG. 2A illustrates an alternative circuit that may be used according to embodiments of the present invention to operate a LCD;

FIG. 3 shows a typical relationship between the resistance and temperature of a thermistor that may be used according to embodiments of the invention.

### DETAILED DESCRIPTION

The present invention is directed to a system and method for providing thermal compensation for LCD contrast control. Embodiments of the system may include a voltage divider circuit incorporating a temperature sensor (such as a thermistor) which alters input current and voltage to the LCD based on the ambient temperature outside the case of an electronic appliance. The temperature sensor need not be thermally coupled to the LCD.

Instead, in embodiments of the invention, the temperature sensor may be placed in a portion of the appliance's interior proximate to a cooling fan or proximate to the LCD so that the temperature sensor is in contact with air immediately drawn in from the outside ambient air. Other temperature sensors may be placed near the LCD panel or may be placed in locations inside the electrical device whose thermal characteristics will be similar to those of the portion of the LCD panel to be measured.

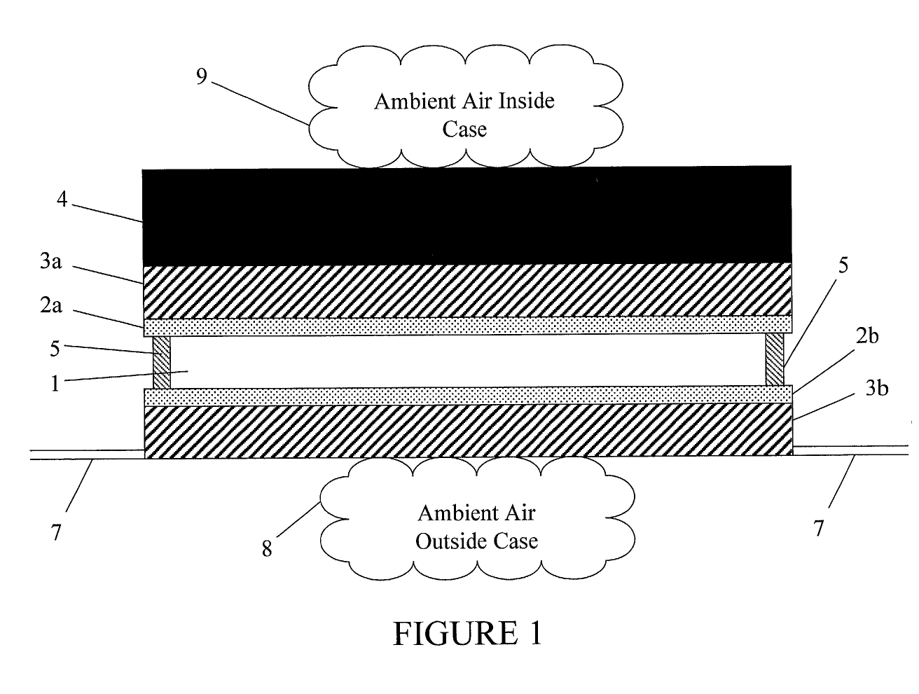

FIG. 1 shows a cross-section of a LCD panel that may be used according to embodiments of the present invention. The LCD panel may include a liquid crystal medium 1. The liquid crystal medium 1 may be contained by the combination of a seal 5, an inner surface of a front electrode layer 2b and an inner surface of a back electrode layer 2a. The electrode layers 2a and 2b may be divided to form individual electrodes associated with each pixel of the LCD panel. The electrode layers 2a and 2b may extend beyond the perimeter seal and be electrically connected to conductors configured to transmit signals from a LCD driver. The signals from the LCD driver may be in the form of a bitmap.

The amount of electric power applied to an individual electrode associated with a particular pixel in the LCD panel in order to cause that pixel to change from the “OFF” state (e.g., not visible) to the “ON” state (e.g., visible) or to produce a desired level of contrast may be dependent in part upon the temperature of the liquid crystal medium 1. Accordingly in embodiments of the present invention, it may be desirable to change the voltage applied to a pixel through a LCD driver to achieve a desired contrast level.

The front electrode layer 2b may have an outer surface in contact with the inner surface of a front plate 3b and the back electrode layer 2a may have an outer surface in contact with the inner surface of a back plate 3a. The outer surface of the front plate 3b may be exposed to the outside ambient 8 outside the electronic appliance case 7. The outer surface of the back plate 3a may be exposed to the inside ambient 9 inside the electronic appliance case 7, which will generally be at a higher temperature than the outside ambient 8 due to heat generated by electronic components (e.g., in a computer or server appliance, a central processing unit or co-processor) inside the electronic appliance case. In the typical layout of an electronic device, a cooling fan may be located at one end of a collection of electronic components (e.g., a motherboard) and the fan may pass air across the collection of electronic components to an exit vent.

In an alternative embodiment shown in FIG. 1, the outer surface of the back plate 3a may be covered by a thermally insulative material 4, so that the temperature of the back plate can be assumed to remain a constant known value. And in another alternative embodiment of the invention, the outer surface of the back plate 3a may be exposed to the outside ambient 8. This may be accomplished by placing a fan in the electronic appliance case 7 so that the fan causes outside ambient 8 to be drawn into the electronic appliance case 7 through an inlet vent and circulated across the outer surface of the back plate 3a. In such an embodiment, the fan may be placed near the LCD panel so that the outside ambient 8 does not absorb significant thermal energy from components inside the electronic appliance case 7 before coming in contact with the outer surface of the back plate 3a.

Where the front plate 3b and the back plate 3a are relatively thin, the thermal gradient from the inner surface of each plate to the outer surface of each plate can be approximated as zero, i.e., it can be assumed that both surfaces of each plate are at the same temperature. Moreover, the temperature of the liquid crystal medium 1 can be approximated as the average of the temperatures of the back plate 3a and the front plate 3b. In an embodiment in which the back plate 3a is exposed to the inside ambient 9, this average may in turn be equal to the average of the temperatures of the outside ambient 8 and the inside ambient 9. Alternatively, in embodiments like that shown in FIG. 1, where the back plate 3a is at a known temperature, this average may be equal to the average of the temperature of the outside ambient 8 and the known temperature. In embodiments in which the back plate is also exposed to the outside ambient 8, this average may be equal to the temperature of the outside ambient 8. In general, the nature of the front plate 3b and back plate 3 a materials, the thicknesses of the front plate 3b and back plate 3 a or other factors may alter the relationship between the temperature of the liquid crystal medium 1, the temperature of the front plate 3b and the temperature of the back plate 3 a. However, the nature of this relationship may be determined through testing of the LCD panel prior to operation or manufacture of the device.

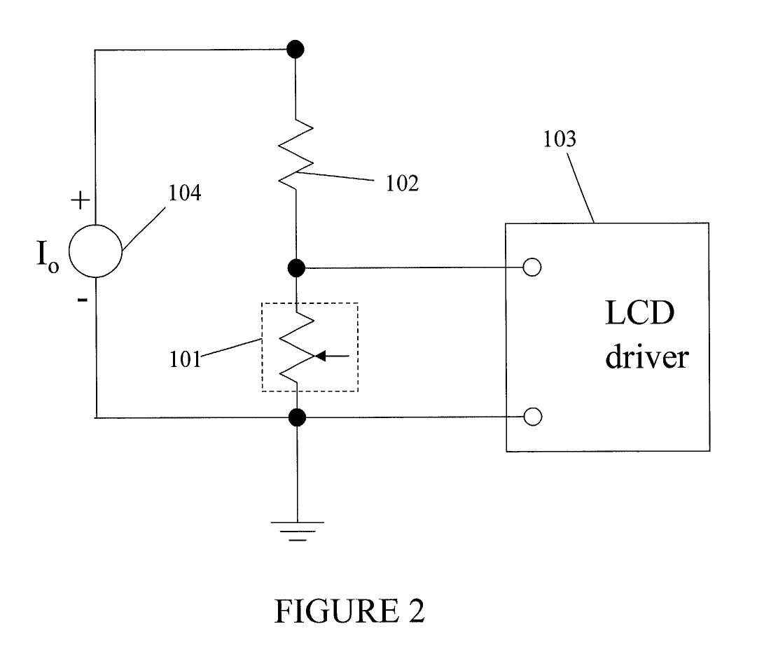

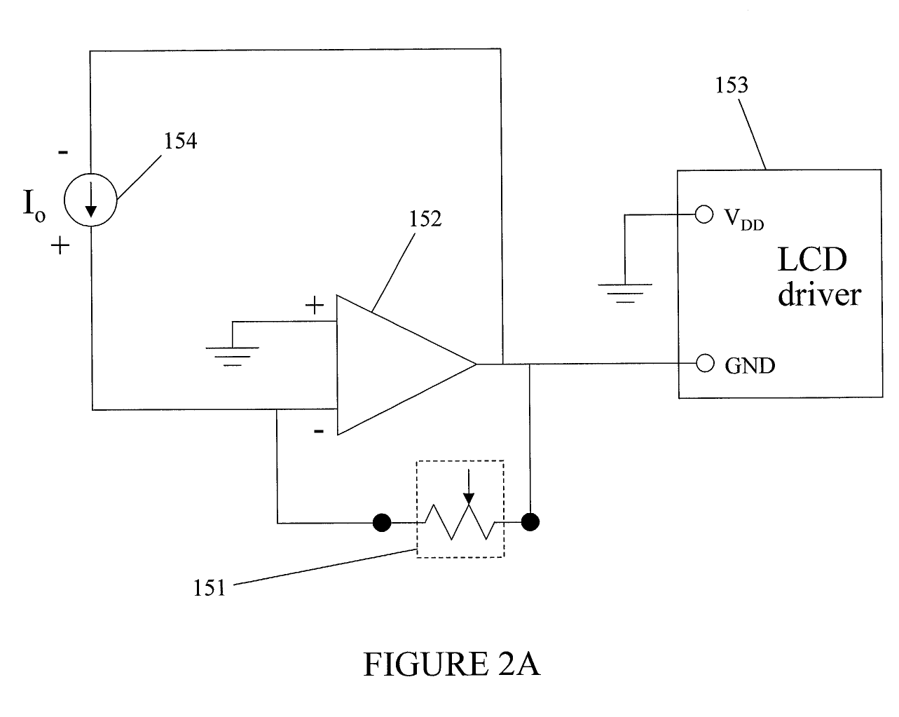

In any of these embodiments, the amount of voltage supplied to a particular LCD pixel to be illuminated may be adjusted based on the temperature of the liquid crystal medium 1. One simple embodiment of a system for accomplishing voltage compensation is shown in FIG. 2. A thermistor 101 may be electrically coupled between ground and the voltage input to a LCD driver 103. The LCD driver 103 may be one of several, each of which is associated with an individual pixel of the LCD panel and which together may form a LCD driver.

In an embodiment of the invention in which the temperature of the outside ambient air is measured to estimate or calculate the temperature of the liquid crystal medium 1, the thermistor 101 may be immersed in outside ambient air that is drawn into the electronic appliance case 7 by a cooling fan. The thermistor 101 may be located upstream of heat-generating electronic components that are also cooled by the fan. As a result, the air in which the thermistor 101 is immersed is at almost the same temperature as the outside ambient air being drawn into the electronic appliance case 7 by the cooling fan. This may be accomplished by locating the thermistor 101 at the end of the circuit board upon which the electronic components are mounted proximate the cooling fan.

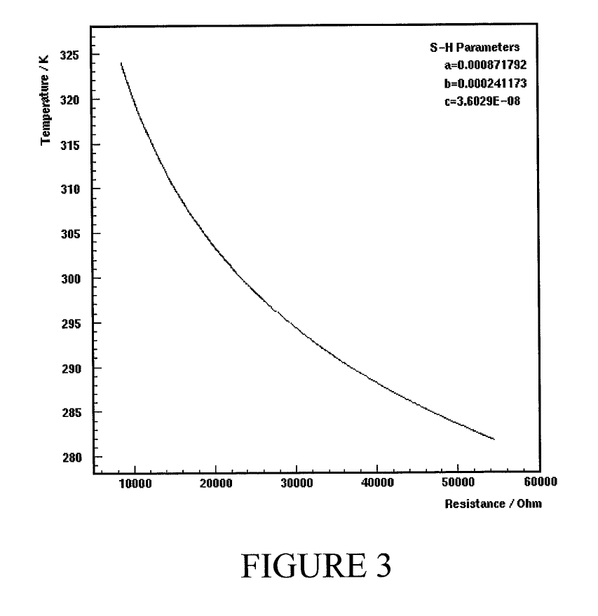

The resistance across the thermistor 101 may be related to the temperature of the thermistor 101 as shown by the graph in FIG. 3. The resistance across the thermistor 101 may increase roughly linearly with the temperature of the thermistor 101. The linear relationship between the resistance across the thermistor 101 and the temperature of the thermistor 101 may be limited to a particular temperature range and the particular thermistor 101 chosen for an application may depend, in part, upon the operational temperature range of the thermistor 101. The resistance of the thermistor 101 may be directly related to the voltage drop across the thermistor 101 in the embodiment of the system shown in FIG. 1.

In general, the compensation voltage applied to the LCD panel depends upon the temperature of the liquid crystal medium 1 relatively linearly. Referring back to FIG. 2, the resistance value of the fixed resistor 102 may be chosen to be compatible with the resistance-temperature relationship of the thermistor 101 to create the desired LCD pixel contrast. In order to accomplish this matching, in some embodiments of the invention, the fixed resistor 102 may be replaced with a combination of fixed or variable resistors connected in series, in parallel or in some combination of the two. For example, in some embodiments, the thermistor 101 may be part of a Wheatstone bridge.

A fixed resistor 102 may be coupled between the voltage input to the LCD driver 103 and a constant voltage source 104 (V_{CL}). Thus, the fixed resistor 102 and the thermistor 101 form a voltage divider in which the voltage input to a LCD driver 103 can be calculated as the voltage of the constant voltage source 104 multiplied by the ratio of the resistance of the thermistor 101 to the combined resistance of the fixed resistor 102 and the thermistor 101. As the resistance of the thermistor 101 decreases (i.e., as the temperature of the thermistor 101 decreases), less voltage is supplied to the LCD driver 103. The voltage V_{CL} of the constant voltage source 104 and the resistance of the fixed resistor 102 may be chosen such that the voltage input to the LCD driver 103 correlates to the desired contrast level.

In other embodiments of the invention, a temperature sensor may be used to control a bias voltage value applied to the LCD driver. For example, in an alternative embodiment of the invention shown in FIG. 2A, a first input of an operational amplifier 152 may be coupled to a constant current source 154 and the other input may be connected to ground. A thermistor 151 may be coupled between the first input of the operational amplifier 152 and the output voltage of the operational amplifier 152. Accordingly, the difference between the output voltage of the operational amplifier 152 and ground will be approximately equal to the product of the current produced by the constant current source 154 and the resistance of the thermistor 151. This difference (or some portion thereof) may be transmitted to the LCD driver 153.

Where high contrast precision is required, digital control circuitry may be incorporated in which the output of a more sensitive temperature sensor is received by a microprocessor or more complex analog control circuitry. The output may be manipulated to calculate the appropriate voltage to input to the pixel of the LCD based on the known relationships between: 1) the temperature and voltage or current output of the temperature sensor; and 2) the temperature of the liquid crystal medium 1 and the voltage that must be input to the LCD driver 103 in order to produce the desired contrast level.

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. A thermal compensation system for an electronic appliance having a case and a LCD panel, said LCD panel having a liquid crystal medium and a plurality of pixels to which voltage may be applied to produce a desired image, said system comprising:
a LCD driver configured to apply voltage to selected ones of said plurality of pixels to produce said desired image, the contrast associated with a particular one of said pixels being dependent upon the temperature of the liquid crystal medium and the voltage applied to said particular one of said plurality of pixels; and
a temperature sensor configured to measure the temperature of an ambient, said temperature sensor being thermally uncoupled from said LCD panel and located within said case, and
wherein the temperature sensor is further configured to change the voltage applied to the selected ones of said plurality of pixels by said LCD driver based upon the temperature of the ambient.

2. The system according to claim 1, wherein said electronic appliance includes a cooling fan, and said ambient is the ambient air outside said case, and said ambient is drawn into said case by said cooling fan through a vent in said case before being passed over said temperature sensor.

3. The system according to claim 2, wherein said temperature sensor is located proximate said cooling fan such that said ambient is passed over said temperature sensor before said ambient collects heat from a heat-generating component within said case.

4. The system according to claim 1, wherein said temperature sensor includes a resistance that depends upon the temperature of the ambient.

5. The system according to claim 4, wherein the voltage applied to the selected ones of said plurality of pixels by said LCD driver is related to a voltage drop across said resistance.

6. The system according to claim 4, further including a constant voltage source and a resistor, and further wherein said constant voltage source, said resistor and said temperature sensor are incorporated into a voltage divider circuit.

7. The system according to claim 1, wherein said ambient is the air inside said case and said temperature sensor is located proximate said LCD panel.

8. The system according to claim 7, wherein said temperature sensor includes a resistance that depends upon the temperature of the ambient.

9. The system according to claim 8, wherein the voltage applied to the selected ones of said plurality of pixels by said LCD driver is related to a voltage drop across said resistance.

10. The system according to claim 8, further including a resistor, and further wherein said resistor and said temperature sensor are incorporated into a voltage divider circuit.

11. The system according to claim 10, wherein said voltage divider circuit further includes a constant voltage source.

12. The system according to claim 1, further including a second temperature sensor for measuring the temperature of a second ambient, and further wherein said voltage applied to the selected ones of said plurality of pixels by said LCD driver is also based upon the temperature of said second ambient.

13. A thermal compensation system for an electronic device having a case, a cooling fan, a LCD panel and a heat-generating component, said LCD panel having a liquid crystal medium and a plurality of pixels to which voltage may be applied to produce a desired image, said system comprising:
a LCD driver configured to apply voltage to selected ones of said plurality of pixels to produce said desired image, the contrast associated with a particular one of said pixels being dependent upon the temperature of the liquid crystal medium and the voltage applied to said particular one of said plurality of pixels; and
a temperature sensor configured to measure the temperature of ambient air outside said case, said temperature sensor being thermally uncoupled from said LCD panel and located within said case, and
wherein the temperature sensor is further configured to change the voltage applied to the selected ones of said plurality of pixels by said LCD driver based upon the temperature of said ambient air outside said case, and
wherein said heat-generating component is located inside said case, and
wherein said cooling fan draws ambient air from outside said case into said case and passes said ambient air by said heat-generating component, and
wherein said temperature sensor is located proximate said cooling fan such that said ambient air is passed by said temperature sensor before said ambient air is passed by said heat-generating component.

14. A thermal compensation system for an electronic device having a case and a LCD panel, said LCD panel having a liquid crystal medium and a plurality of pixels to which voltage may be applied to produce a desired image, said system comprising:
a LCD driver configured to apply voltage to selected ones of said plurality of pixels to produce said desired image, the contrast associated with a particular one of said pixels being dependent upon the temperature of the liquid crystal medium and the voltage applied to said particular one of said plurality of pixels; and
a thermistor configured to measure the temperature of an ambient, said thermistor being thermally uncoupled from said LCD panel and located within said case, and
wherein the thermistor is further configured to change the voltage applied to the selected ones of said plurality of pixels by said LCD driver based upon the temperature of the ambient.

15. A thermal compensation system for an electronic device having a case and a LCD panel, said LCD panel having a liquid crystal medium and a plurality of pixels to which voltage may be applied to produce a desired image, said system comprising:
a LCD driver configured to apply voltage to selected ones of said plurality of pixels to produce said desired image, the contrast associated with a particular one of said pixels being dependent upon the temperature of the liquid crystal medium and the voltage applied to said particular one of said plurality of pixels; and
a voltage divider circuit including a thermistor and a resistor, said thermistor being configured to measure the temperature of an ambient, and being thermally uncoupled from said LCD panel, and being located within said case, and
wherein the thermistor is further configured to change the voltage applied to the selected ones of said plurality of pixels by said LCD driver based upon the temperature of the ambient.

16. A method for providing thermal compensation for a LCD panel in an electronic appliance, said LCD panel including a front panel, a back panel, a plurality of pixels and a liquid crystal medium, and said electronic appliance including a case, said method comprising:
placing a temperature sensor inside said case, said temperature sensor being thermally uncoupled from said LCD panel;
passing an ambient over said temperature sensor, said ambient being in contact with one of said front panel and said back panel;
measuring the temperature of said ambient using said temperature sensor;
applying a voltage to selected ones of said plurality of pixels to create an image; and
altering said voltage based upon said temperature of said ambient.

17. The method according to claim 16, wherein said temperature sensor includes a thermistor and said voltage is altered based upon a voltage drop across said thermistor.

18. The method according to claim 17, further including coupling said thermistor to a second resistor so as to form a voltage divider.

19. The method according to claim 16, wherein said voltage is applied to said selected ones of said plurality of pixels through a LCD driver.

20. The method according to claim 19, wherein said voltage is altered by applying a bias voltage to said LCD driver.

21. The method according to claim 16, wherein said ambient is in contact with said front panel and said method further including drawing said ambient into said case.

22. An electronic appliance comprising:
a case;
a LCD panel having a liquid crystal medium and a plurality of pixels;
a LCD driver configured to apply a voltage to selected ones of said plurality of pixels to produce a desired image, the contrast associated with a particular one of said pixels being dependent upon the temperature of the liquid crystal medium and the voltage applied to said particular one of said plurality of pixels; and
a temperature sensor configured to measure the temperature of an ambient, said temperature sensor being thermally uncoupled from said LCD panel and located within said case, and
wherein the temperature sensor is further configured to change the voltage applied to the selected ones of said plurality of pixels by said LCD driver based upon the temperature of the ambient.

23. The electronic appliance of claim 22, wherein said ambient is ambient air outside said case and said electronic appliance.

24. The electronic appliance of claim 23, further including a cooling fan, said cooling fan configured to draw said ambient air into said case and further configured to pass said ambient air by said temperature sensor.

25. The electronic appliance of claim 24, further including a heat-generating component and further wherein said temperature sensor is located between said fan and said heat-generating component.

26. The electronic appliance of claim 22, further including a voltage divider circuit including said thermistor and a resistor.

27. The electronic appliance of claim 26, said voltage divider circuit further including a constant voltage source.
